(19) United States
(12) Patent Application Publication
(10) Pub. No.: US 2021/0241370 A1
(43) Pub. Date: Aug. 5, 2021

(54) SYSTEM AND METHOD FOR FINANCIAL SERVICES FOR ABSTRACTION OF ECONOMIES OF SCALE FOR SMALL BUSINESSES

(71) Applicant: RockSpoon, Inc., San Jose, CA (US)

(72) Inventor: Nagib Georges Mimassi, Palo Alto, CA (US)

(21) Appl. No.: 17/074,316

(22) Filed: Oct. 19, 2020

Related U.S. Application Data
(63) Continuation-in-part of application No. 17/037,256, filed on Sep. 29, 2020.
(60) Provisional application No. 62/975,674, filed on Feb. 12, 2020.
(60) Provisional application No. 62/969,851, filed on Feb. 4, 2020.

(51) Int. Cl. G06Q 40/02; G06Q 20/40; G06K 9/00

(52) U.S. Cl. CPC G06Q 40/025; G06K 9/00456; G06Q 20/4016

(57) ABSTRACT

A system and method facilitating financing for small businesses, including the use of fractional reserve banking, optimizing the reserve required for the financing system based on costs including inventory, payroll, rent, and other bills, billing and payment processing, optimization of timing for supply purchases based on inventory and delivery time for applicable businesses, support for payment plans, business and individual-specific lines of credit, restaurant and employee credit ratings, expense tracking, and optical recognition of scanned bills for scanning bills into a business's account or splitting the bill between parties on the platform.

### CROSS-REFERENCE TO RELATED APPLICATIONS

| Application No. | Date Filed | Title |
|---|---|---|
| Current | Herewith | PERSONALIZED FOOD ITEM DESIGN AND |
| application | | CULINARY FULFILLMENT SYSTEM |
| | | Claims benefit of, and priority to: |
| 62/975,674 | Feb. 12, 2020 | SYSTEM AND METHOD FOR FINANCIAL |
| | | SERVICES FOR ABSTRACTION OF |
| | | ECONOMIES OF SCALE FOR SMALL |
| | | BUSINESSES |
| | | and is also a continuation-in-part of: |
| 17/037,256 | Sep. 29, 2020 | A SYSTEM AND METHOD FOR SMALL |
| | | BUSINESS SERVICE AGGREGATION AND |
| | | ABSTRACTION OF ECONOMIES OF SCALE |
| | | which claims benefit of, and priority to: |
| 62/969,851 | Feb. 4, 2020 | SYSTEM AND METHOD FOR SMALL |
| | | BUSINESS SERVICE AGGREGATION AND |
| | | ABSTRACTION OF ECONOMIES OF SCALE |

the entire specification of each of which is incorporated herein by reference.

### BACKGROUND OF THE INVENTION

### Field of the Art

The disclosure relates to the field of financial services, more specifically the field of aggregation of financial services to enable economies of scale for small businesses,

### Discussion of the State of the Art

An economy of scale is a useful concept in business, and reflects an all-too-true reality, in which a large-scale manufacturer or seller of some sort may experience lower cost-per-item than a smaller business, because of the advantages of having large infrastructure and being able to produce, sell, or otherwise market large quantities of items at a time, driving the cost-per-item down for large merchants, such as AMAZON™, WALMART™, or APPLE™. Any single person or local business has trouble competing with these companies at their own game, whether it is selling a variety of goods in a brick-and-mortar store, selling books specifically, or making and selling phones (which is almost entirely impossible for a small-scale operation to even achieve to begin with). But there are further benefits besides manufacture and sale of goods, for economies of scale, that aid large businesses but do not aid smaller ones.

Delivery infrastructure and centralization of logistics and finance are some of the biggest economy-of-scale boons for large, national or multinational corporations, to the point where some companies even have their own delivery services exclusively. A local store does not have these benefits typically, and might have to self-manage their deliveries—if any—through a normal postal system at greater inconvenience to themselves and their customer, and sometimes greater cost. The finances, bill payments, payroll, and more, are also often not easily centralized or automated for many smaller businesses.

Further, a business and employee-level rating of credit-worthiness to issue business lines of credit and business credit cards, for small businesses, integrated with a bill and payroll payment system and bill management system, does not exist in an efficient or commonly used context in the market. Many economy-of-scale services of this nature are not provided to smaller businesses because of the nature of economies of scale, in which more favorable financial realities are available to larger corporations.

### SUMMARY OF THE INVENTION

Accordingly, the inventor has conceived and reduced to practice, in a preferred embodiment of the invention, a system and methods for financial services for abstraction of economies of scale for small businesses. The following non-limiting summary of the invention is provided for clarity, and should be construed consistently with embodiments described in the detailed description below.

A system has been devised for financial services for abstraction of economies of scale for small businesses, comprising: a financing system application server comprising at least a processor, a memory, and a first plurality of programming instructions stored in the memory and operating on the processor, wherein the programming instructions, when operating on the processor, cause the processor to: accept connections over a network from users; register users as business personnel with proper documentation; allow users to register the business they operate within as a business entity in the application server; acquire information about business and all key personnel, if any, through the registered user; determine creditworthiness of business entity and any key personnel; deliver loan agreements and associated funds for specified uses to registered business entity; wherein the loan funds may be utilized for business costs including delivery and shipment of goods, payroll, corporate expenses, and utility bills associated with the business entity; allow a business entity to deposit funds manually or automatically through scheduled payments; utilize fractional reserve banking techniques to use deposited funds to finance other businesses or operations associated with the application server; wherein the fractional reserve banking techniques are optimized based on the business entity's expected and historical costs and timing of withdrawals and payments; develop an individual credit worthiness rating for each business entity and key person associated with the business entity; wherein the individual credit worthiness ratings are used to allow for credit to be issued to each business entity and key person with rates and maximums individual to the business entity and key person in question; detect and recognize characters optically in a scanned bill for the purpose of digital financing of bills; interface with third party entities including at least third party delivery companies on behalf of the registered business entity; facilitate payment for services including to third party entities on behalf of the registered business entity; and detect fraudulent bill recognition attempts and fraudulent transactions on the part of either or both of a business entity or a key person or multiple key personnel.

A method has been devised for financial services for abstraction of economies of scale for small businesses, comprising the steps of: accepting connections over a network from users, using a financing system application server; registering users as business personnel with proper documentation, using a financing system application server; allowing users to register the business they operate within as a business entity in the application server, using a financing system application server; acquiring information about business and all key personnel, if any, through the registered user, using a financing system application server; determining creditworthiness of business entity and any key personnel, using a financing system application server; delivering loan agreements and associated funds for specified uses to registered business entity, using a financing system application server; wherein the loan funds may be utilized for business costs including delivery and shipment of goods, payroll, corporate expenses, and utility bills associated with the business entity, using a financing system application server; allowing a business entity to deposit funds manually or automatically through scheduled payments, using a financing system application server; utilizing fractional reserve banking techniques to use deposited funds to finance other businesses or operations associated with the application server, using a financing system application server; wherein the fractional reserve banking techniques are optimized based on the business entity's expected and historical costs and timing of withdrawals and payments, using a financing system application server; developing an individual credit worthiness rating for each business entity and key person associated with the business entity, using a financing system application server; wherein the individual credit worthiness ratings are used to allow for credit to be issued to each business entity and key person with rates and maximums individual to the business entity and key person in question, using a financing system application server; detecting and recognize characters optically in a scanned bill for the purpose of digital financing of bills, using a financing system application server; interfacing with third party entities including at least third party delivery companies on behalf of the registered business entity, using a financing system application server; facilitating payment for services including to third party entities on behalf of the registered business entity, using a financing system application server; and detecting fraudulent bill recognition attempts and fraudulent transactions on the part of either or both of a business entity or a key person or multiple key personnel, using a financing system application server.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary system for financial services for abstraction of economies of scale for small businesses, according to an aspect.

FIG. 2 is a diagram of an exemplary application used in a system for financial services for abstraction of economies of scale for small businesses, according to an aspect.

FIG. 3 is a method diagram of an exemplary system for financial services for abstraction of economies of scale for small businesses, according to a preferred embodiment of the invention.

FIG. 4 is a method diagram illustrating the system being used to order wares (i.e. supplies for a restaurant), optimize the timing from the perspective of inventory numbers and estimated delivery time, handle the money for such transactions as a business line of credit, and communicate with the third party to complete the order.

FIG. 5 is a method diagram illustrating a financial application evaluating credit worthiness of businesses, employees, issuing and utilizing credit cards based on evaluations of individuals and businesses.

FIG. 6 is a method diagram illustrating a financial application tracking corporate expenses, scheduling payments for bills and other regular payments through the application as a creditor, and using Optical Character Recognition (“OCR”) to scan photographs of bills or invoices.

FIG. 7 is a method diagram of a financial application and accompanying system being used similarly to a fractional reserve banking system, where a business deposits funds, and a portion of the deposited money is used to fund other customers' credit.

FIG. 8 is message flow diagram of an exemplary system for financial services for abstraction of economies of scale for small businesses, according to a preferred embodiment of the invention.

FIG. 9 is a message flow diagram illustrating the system being used to order wares (i.e. supplies for a restaurant), optimize the timing from the perspective of inventory numbers and estimated delivery time, handle the money for such transactions as a business line of credit, and communicate with the third party to complete the order.

FIG. 10 is a message flow diagram illustrating a financial application evaluating credit worthiness of businesses and employees, and issuing and utilizing credit cards based on evaluations of individuals and businesses.

FIG. 11 is a message flow diagram illustrating a financial application tracking corporate expenses, scheduling payments for bills and other regular payments through the application as a creditor, and using Optical Character Recognition (“OCR”) to scan photographs of bills or invoices.

FIG. 12 is a message flow diagram of a financial application and accompanying system being used similarly to a fractional reserve banking system, where a business deposits funds, and a portion of the deposited money is used to fund other customers' credit.

FIG. 13 is a block diagram illustrating an exemplary hardware architecture of a computing device.

FIG. 14 is a block diagram illustrating an exemplary logical architecture for a client device.

FIG. 15 is a block diagram showing an exemplary architectural arrangement of clients, servers, and external services.

FIG. 16 is another block diagram illustrating an exemplary hardware architecture of a computing device.

### DETAILED DESCRIPTION

The inventor has conceived, and reduced to practice, a system and method for . . .

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

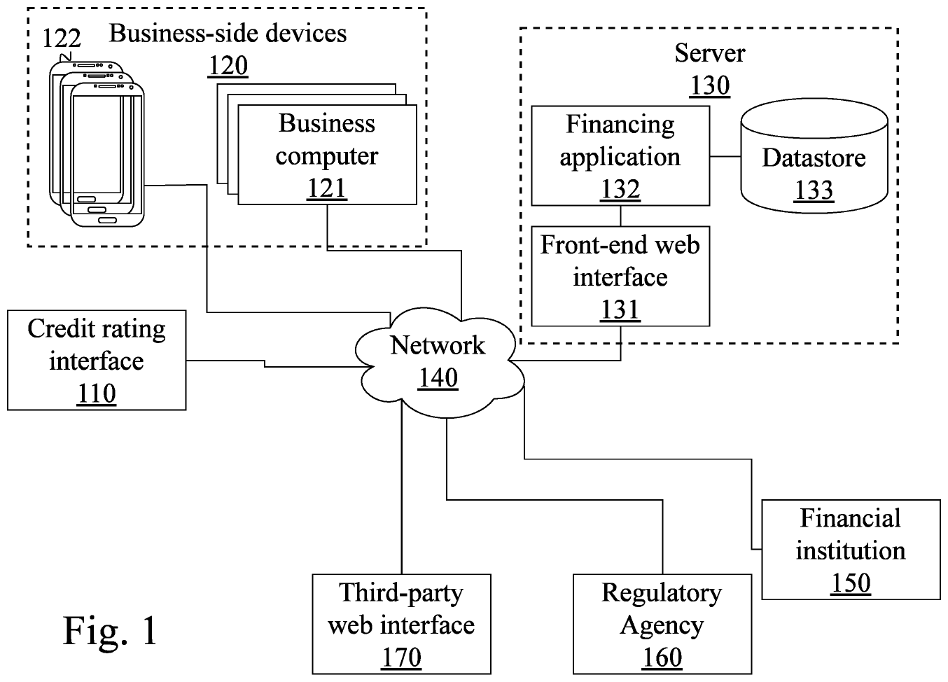

FIG. 1 is a diagram of an exemplary system for financial services for abstraction of economies of scale for small businesses, according to an aspect. A Credit rating interface 110 exists as a software interface accessible over a network 140 by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computers 121 and business-side mobile device 122, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer 121 refers to a laptop or desktop, or similar computing device that is not normally considered a “mobile device” as a tablet or phone is, but which also may communicate over a network and operate complex software such as web browsers and applications. A server 130 exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore 133 to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore 133 may be a database such as a SQL or NOSQL database, it may be a connection to cloud storage on another service such as one with WINDOWS AZURE™ or other cloud service providers, or may be another implementation of a datastore that may be used for server storage. The server 130, business-side devices 120, credit rating interface 110, and other services or interfaces, communicate with some combination of each other or other services and devices over a network 140, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls.

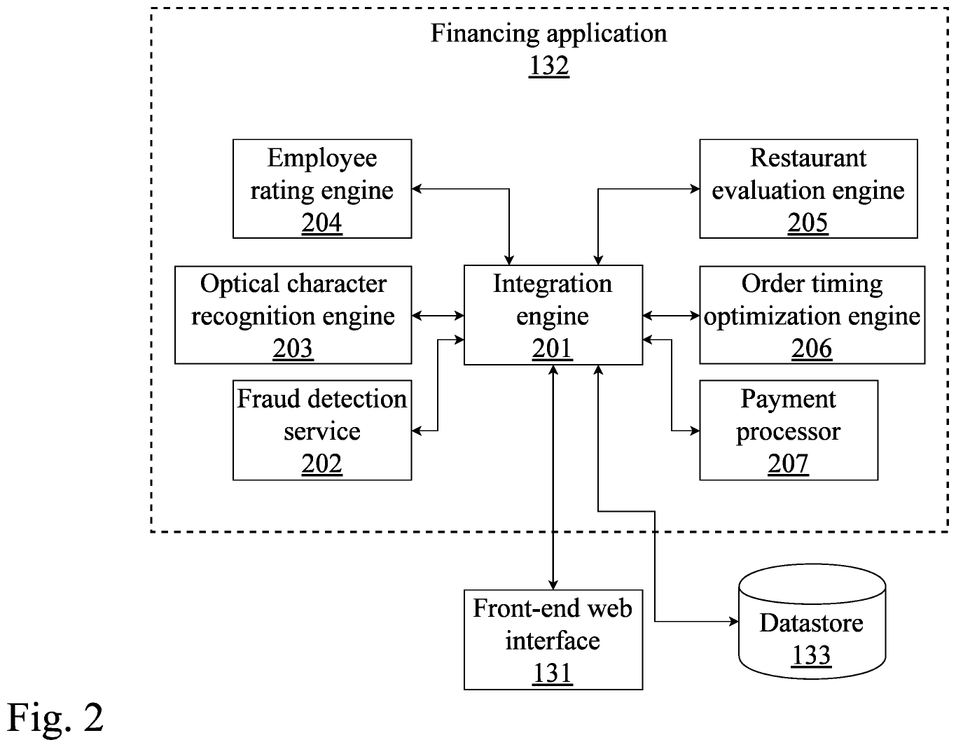

FIG. 2 is a diagram of an exemplary application used in a system for financial services for abstraction of economies of scale for small businesses, according to an aspect. A financing application 132 exists which represents the back-end logic of the server's main application and which comprises many software engines and components to offer specific operations and functionality to users, and a datastore 133 to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. Software components that comprise the operation of the financing application 132 include an integration engine 201, a fraud detection service 202, an optical character recognition engine 203, an employee rating engine 204, a restaurant evaluation engine 205, an order timing optimization engine 206, and a payment processor 207. An integration engine serves as a go-between to manage the communications and inter-operability between the various engines, services, and interfaces that make up the financial application 132, and may be thought of as the main “driver” of the application as a whole. A fraud detection service 202 may communicate with regulatory agencies and/or financial institutions for a given account or individual associated with an account on the application, to determine if questionable or dubious account transactions take place, such as transactions that take place from two distant locations within a very short period of time, or purchases made for non-business-related items, which may be specified by the account holder in their personal settings regarding fraud detection. An optical character recognition engine 203 is a piece of software that may receive as input an image or PDF, and recognize characters such as English letters from optical recognition, a common technology in the art. Such optical character recognition may be used to scan bills and invoices into the application for many purposes including splitting a bill between registered parties, storing digital records of received bills, and more. An employee and restaurant evaluation or rating engine 204, 205 are both software components that may use credit reporting information received from a credit reporting agency or similar, along with application-specific knowledge of an individual's or business' operations and habits and actions with the financial application, to determine how much credit may be safely lent to them, in a manner similar to credit rating agencies. The difference here is that the fine-tuning of how the parameters of an individual or business are calculated and weighed may be different from other credit agencies, and may be altered on an as-needed basis for individual businesses or personnel in businesses, and may be used to issue lines of credit or individual credit cards to such businesses or personnel that have specific terms and limits attached that are designed for those individuals or businesses specifically, rather than being tied to a “type” or “rank” or “level” of card or credit worthiness for all businesses and individuals of that “level.” An order timing optimization engine 206 may be used to calculate, based on stored data in a datastore 133, the time it will take for a given order to be received by the business, including the travel delay from the supplier or deliverer as well as the time before the order is actually needed, to ensure the order is received when needed. A payment processor 207 is a software service that interfaces with any financial institution or institutions preferred and specified by the business to withdraw or deposit funds as necessary, for various operations of the application, as approved by the business. The payment processor may also handle payments from the business or the business' credit with the application to other services such as delivery services for stock replenishment, depending on the authorization for such services from the business.

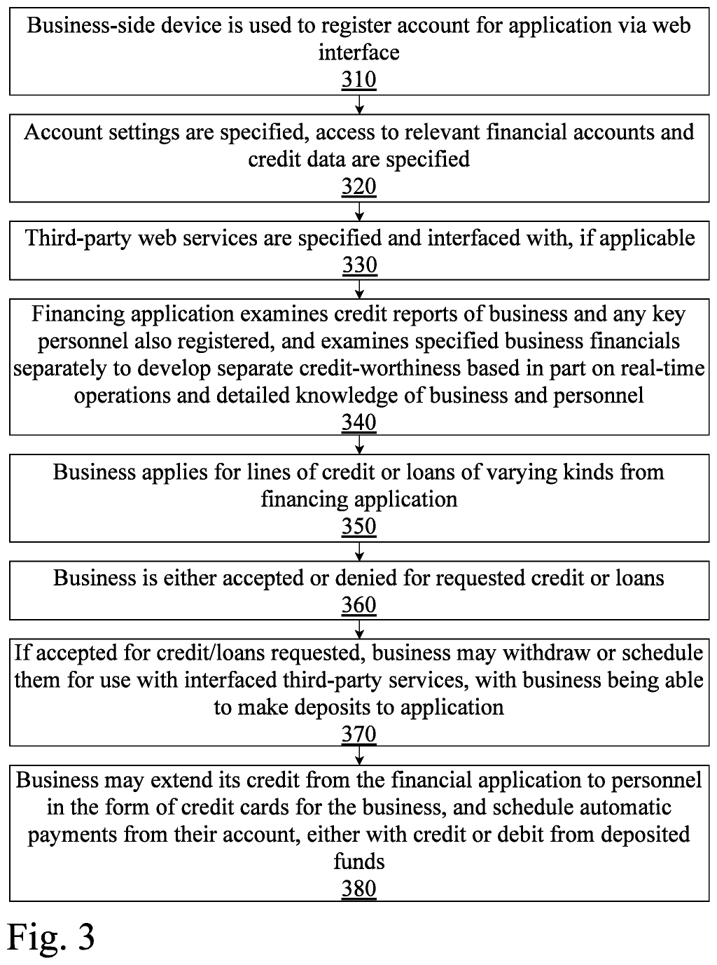

FIG. 3 is a method diagram of an exemplary system for financial services for abstraction of economies of scale for small businesses, according to a preferred embodiment of the invention. First a business-side device is used to register account for application via web interface 310, which may be accomplished either through an application on the business-side device such as a mobile application or a desktop application, or may be accomplished on a website with a web browser such as OPERA™, SAFARI™, GOOGLE CHROME™, MICROSOFT EDGE™, or others. Registration may comprise at least a user to provide information on their identity and their business' identity, login credentials, afterwards a user may specify further account settings, including access to relevant financial accounts and credit data 320, third-party web services if applicable 330 such as, for instance, a bank account number and routing number, or PAYPAL™ credentials to allow for deposits and withdrawals for paying bills and debts depending on the financial settings specified by the business account administrator. Other third party services that may be interfaced with may include delivery services and wholesalers, for automated re-purchasing of goods on a schedule or parsing of emails sent from delivery services to provide for accurate delivery updates within the application. A financing application may examine credit reports of business and any key personnel also registered, based on identity information provided, and examine specified business financials separately to develop separate credit worthiness report based in part on real-time operations and detailed knowledge of business and personnel 340, as the application is used. For instance, if a business is always on-time paying off debts to the institution operating the financial application, and is responsible with their credit, this may reflect favorably on them, but if their business does not perform more than $1,000,000 worth of revenue annually, it might be determined that they should not be permitted to have an amount of credit beyond a certain point, such as $100,000 or some other number. A business may apply for lines of credit or loans of varying kinds from the financing application 350, which may be separate from lines of credit or credit cards received or issues from other financial institutions, and may be used for short-term lending such as paying for supplies to replenish the business' stores if they don't have the funds immediately on hand for the purchase. The business is either accepted or denied for requested credit or loans 360, but if accepted for credit and/or loans, the business may withdraw funds from them and use them manually or schedule them for use with interfaced third-party services, with business being able to make deposits to application 370. Payment plans may be utilized and structured independently for each business or person, in a way that allows for different businesses to have different payment schedules or pay-off times, as the case may be. The business may also extend its credit from the financial application to business personnel in the form of credit cards for business-related uses such as travel costs or supplies for the operation of the business or the personnel in their capacity as employees of the business, and schedule automatic payments from their account, either with credit or debit from deposited funds 380, which is done with a payment processor in the application used. For example, a business may schedule a monthly payment on the 5^{th} of each month of $5,000 to go to a bank to pay off a loan for the purchase of an office space, until some future month, such as January of the year 2023, when the last payment will be made. The payments will then be handled from the financial application and the payments to the specified bank will be made against the business' credit or debit depending on if they have a positive account balance and an approved credit line or not, and therefore the application may, through the use of this function to pay multiple different regular bills, become a centralized location to pay bills, invoices, debts, and more, while paying only one provider.

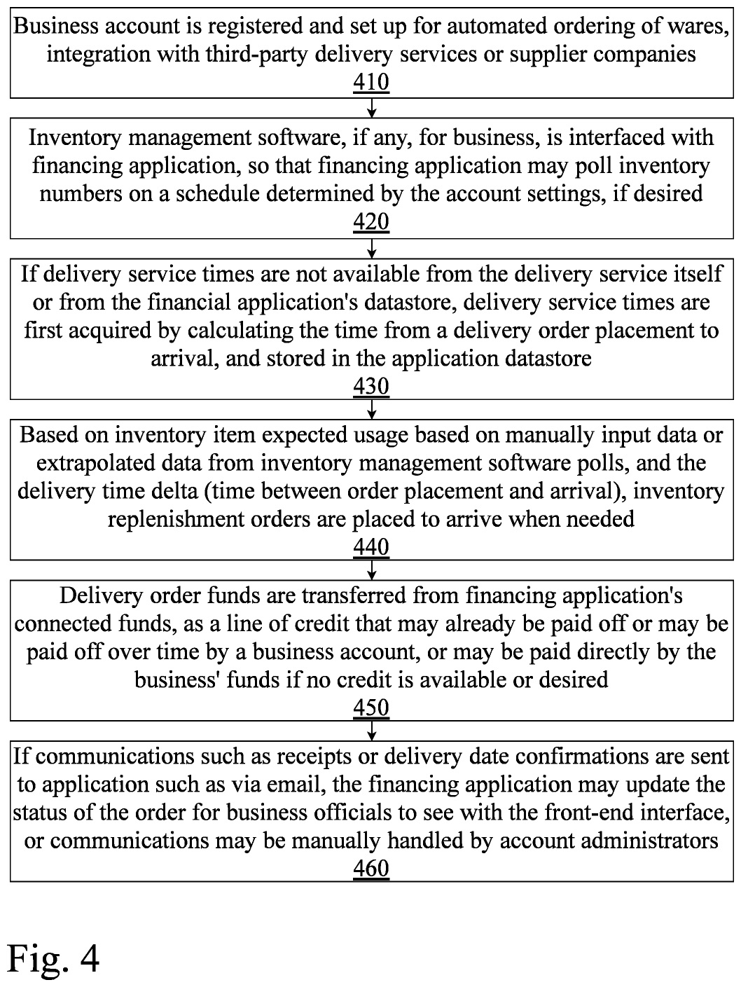

FIG. 4 is a method diagram illustrating the system being used to order wares (i.e. supplies for a restaurant), optimize the timing from the perspective of inventory numbers and estimated delivery time, handle the money for such transactions as a business line of credit, and communicate with the third party to complete the order. A business account is first registered and may set up automated ordering of wares via integration with third-party delivery services or supplier companies 410, which may be accomplished with specialized integration software on the side of the third-party service such as an API that may be called automatically to order wares when provided with proper credentials and financing details. If third party software connected to the business account includes inventory management software or similar, it may be interfaced with via at least parsing text and datastore entries of inventory data by the financing application, so that the financing application may poll inventory numbers on a schedule determined by the account settings, if desired 420. If a delivery service's delivery times (such as “5-10 business days to reach you”) are not available from the delivery service itself or from the financial application's datastore, delivery times are first acquired by calculating the time from a delivery order placement to arrival, and stored in the application datastore 430, so that such data can be used in the future to estimate the optimal timing for delivery orders to be placed based on inventory item expected usage. Such inventory usage expectations may be based on manually input data or extrapolated data from inventory management software polls if inventory software is integrated with the financial application, and when combined with the delivery time delta (time between order placement and arrival), inventory replenishment orders may be placed in such a way as to arrive when needed 440. For instance, if inventory usage data shows that an item is decreasing by an average of 5 items every business day, and there are only 50 more items in stock, and a delivery shipment from the supplier takes 5 to 10 business days to arrive, a new order may be placed now, so that it arrives when the inventory is approximately depleted, or sooner. Delivery order funds are then transferred from the financing application's connected funds, as a line of credit that may already be paid off or may be paid off over time by a business account, or may be paid directly by the business' funds if no credit is available or desired 450. In this way, the application may be used as a fund holder if credit is not used, desired, or approved, but otherwise may be used as a centralized source of credit to play orders and manage inventory for the business, rather than having multiple institutions or websites or applications to go through for credit management, fund management, payment plans, and ordering shipments. If communications such as receipts or delivery date confirmations are sent to the application, for instance via email, from the delivery organization, the financing application may update the status of the order for business officials to see with the front-end interface, or communications may be manually handled by account administrators 460

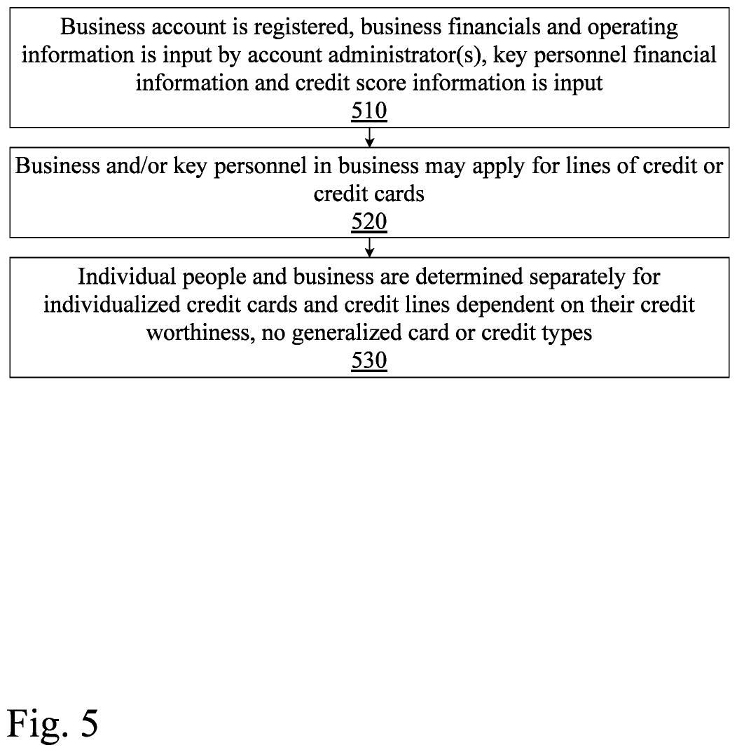

FIG. 5 is a method diagram illustrating a financial application evaluating credit worthiness of businesses, employees, issuing and utilizing credit cards based on evaluations of individuals and businesses. After a business account is registered with a financial application, business financials and operating information are input by the account administrator or administrators, along with key personnel financial information and credit score information 510. For instance, social security numbers of the key personnel listed in and/or managing the account, tax ID for the business, the names of the personnel, and such. Business ops information including revenue, operating income, outstanding loans, and even possibly a breakdown of profit by segment of the business, may be input for increased likelihood of being approved for credit from the financial application, at which point the business and/or key personnel in the business may apply for lines of credit or credit cards 520, when they feel they have input all the information they need to and wish to. Individual personnel and businesses may also be evaluated separately for individualized credit cards and credit lines dependent on their credit worthiness, rather than having templates for “levels” or “tiers” of credit cards which are common in many lending organizations 530, allowing for individualized treatment and evaluation for lending.

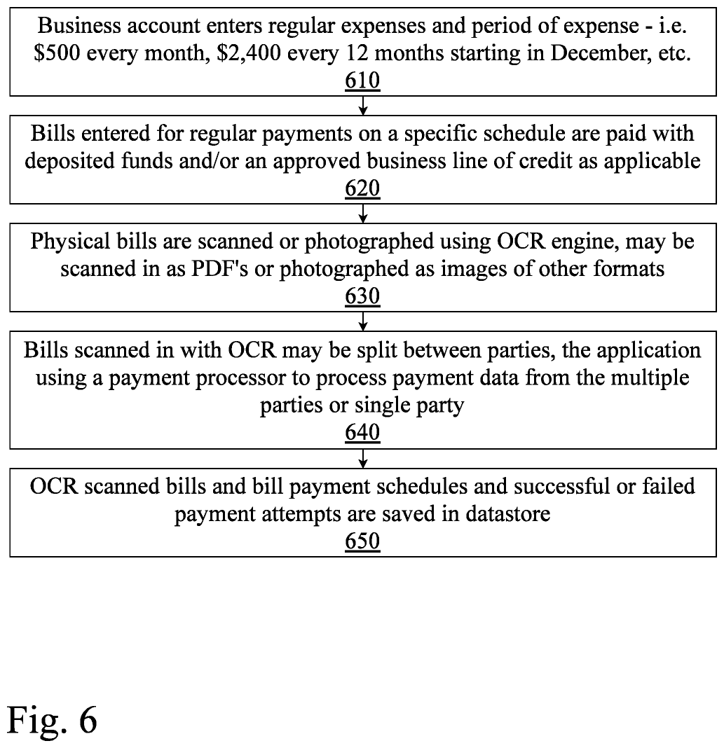

FIG. 6 is a method diagram illustrating a financial application tracking corporate expenses, scheduling payments for bills and other regular payments through the application as a creditor, and using Optical Character Recognition (“OCR”) to scan photographs of bills or invoices. A business account may enter regular expenses and the period of the expense—i.e. $500 every month, $2,400 every 12 months starting in December, etc. 610, which constitutes a regular payment to a specific source that they may specify, but not necessarily one that will be paid in the system, merely one that will be tracked for record-keeping purposes. Bills which are, however, entered for regular payments on a specific schedule are paid with deposited funds and/or an approved business line of credit as applicable 620, such as by using PAYPAL™ or STRIPE™ or direct bank-to-bank deposits, as the cases may be, while allowing for physical bills to be scanned or photographed using a mobile device or an office scanner, and, using the OCR engine in the financial application, may be scanned in as PDF's or photographed as images of other formats and have their characters recognized 630. Bills scanned in this manner and recognized with OCR may then be split between parties, such as splitting between personnel under the same business account or even splitting a bill between multiple business accounts that may log in and consent to the splitting of the bill, with the application using a payment processor to process payment data from the multiple parties or single party for the bill 640. OCR-recognized bills, and such bill payment schedules, and successful or failed payment attempts, are all then saved in the application's datastore 650, for recordkeeping purposes, for all involved users and accounts.

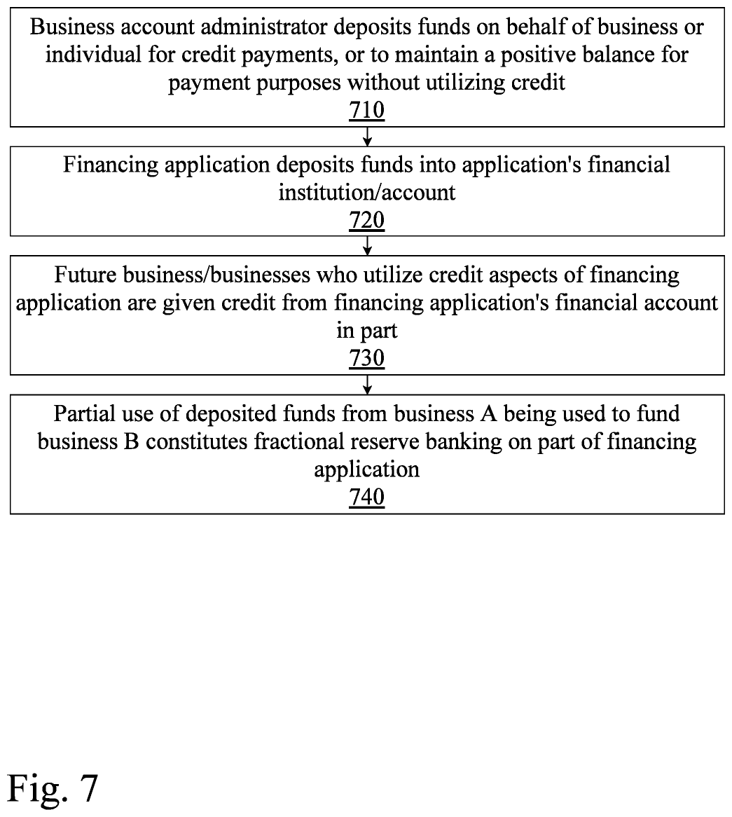

FIG. 7 is a method diagram of a financial application and accompanying system being used similarly to a fractional reserve banking system, where a business deposits funds, and a portion of the deposited money is used to fund other customers' credit. A business account administrator deposits funds on behalf of business or individual for credit payments, or to maintain a positive balance for payment purposes without utilizing credit 710, using the payment processor of the financial application, at which point the financing application deposits funds into application's financial institution/account 720. At this point, future businesses who utilize credit aspects of financing application are given credit from the financing application's financial account 730, partial use of deposited funds from business A being used to fund business B constitutes fractional reserve banking on part of financing application 740. For instance, say that the financing application has received $5,000 on a loan payment from Business A. Business B then is approved for a line of credit and needs to use $4,500 to pay for a renovation of a room in their office that was damaged in a small fire. The $4,500 that is lent to Business B comes from the payment that Business A made, thereby allowing Business A to pay off their debt while keeping liquidity high for future businesses that require money lending.

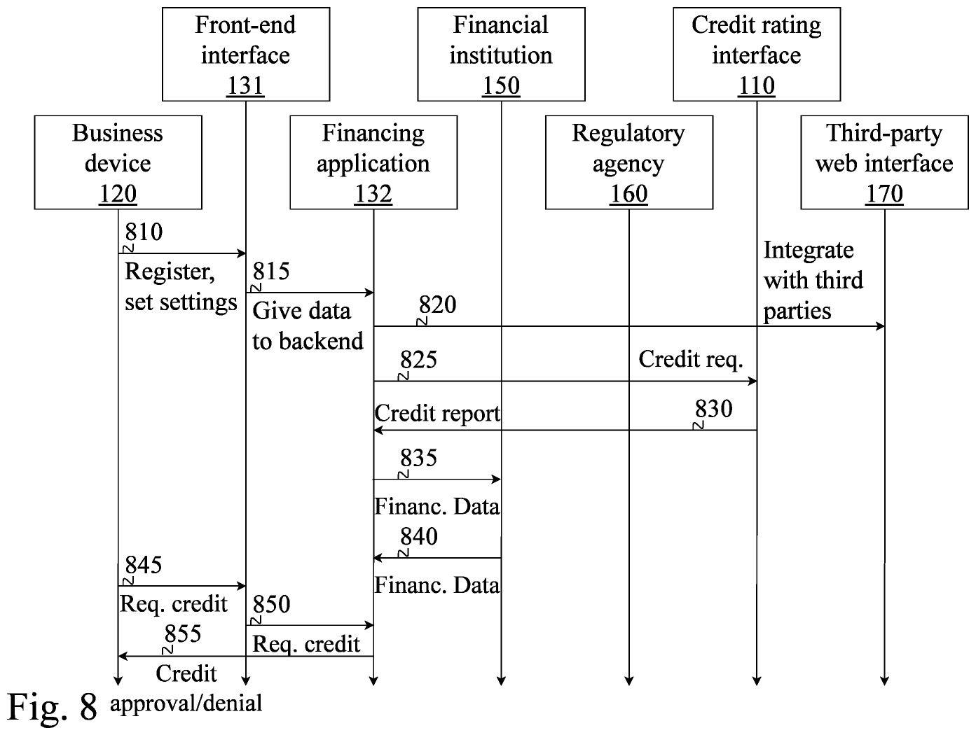

FIG. 8 is message flow diagram of an exemplary system for financial services for abstraction of economies of scale for small businesses, according to a preferred embodiment of the invention. A Credit rating interface 110 exists as a software interface accessible over a network by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computer or computers, or a business-side mobile device or devices, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer refers to a laptop or desktop, or similar computing device that is not normally considered a “mobile device” as a tablet or phone is, but which also may communicate over a network and operate complex software such as web browsers and applications. A server exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore may be a database such as a SQL or NOSQL database, it may be a connection to cloud storage on another service such as one with WINDOWS AZURE™ or other cloud service providers, or may be another implementation of a datastore that may be used for server storage. The server, business-side devices 120, credit rating interface 110, and other services or interfaces, communicate with some combination of each other or other services and devices over a network, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls. First, a business device sends a registration and settings communication to the front-end interface of the financing application 810. This front-end interface serves to interface with customer devices, and forwards the data to the back-end application 815, where it then, depending on the specific settings received from the registered user, may attempt to interface or integrate with third-party services 820. Such an attempt at interfacing or integration may be different for different services, and may comprise one of or some combination of, communicating over established API's for the third-party services, accessing special or sequestered databases for the third-party services to find relevant data to act on regarding the customer, a specialized socket connection with software to receive and send automated messages to the financial application, or merely sending automated emails to service providers and parsing their responses (which may also be automated) in an effort to at least partially integrate with them. At this point, based on the input identifying information from a business which seeks to use the financial application, a credit data request is made to credit score or credit rating institutions 825, which takes the form of a typical credit report request to the institution. The individual's, or business', credit report, is then handed back to the financial application 830, at which point a similar request for information is made of any linked or specified financial institutions for a business, 835. For instance, a business may specify that they do their banking with CHASE BANK™, and provide their banking number, routing number, and SSN, so that a request for a banking statement may be made, though a user may be made aware of this ahead of time to comply with local laws. The financial institution may respond with data including accounts and balances, banking statements, and scheduled payments, if any 840. At this point, the system is ready for a user to request a business credit card, or line of credit 845, on the application front-end, if they so choose. Using the GUI of the front-end for the application they may specify their purpose for requesting the credit, and any additional financial or credit rating related information if necessary, at which point the request and data is forwarded to the back-end logic again 850, and the application may approve or deny the credit requests 855 based on a confluence of factors, the specific formulation of the credit rating for businesses not being a key innovation of the invention and which may be subject to change for implementations of the invention.

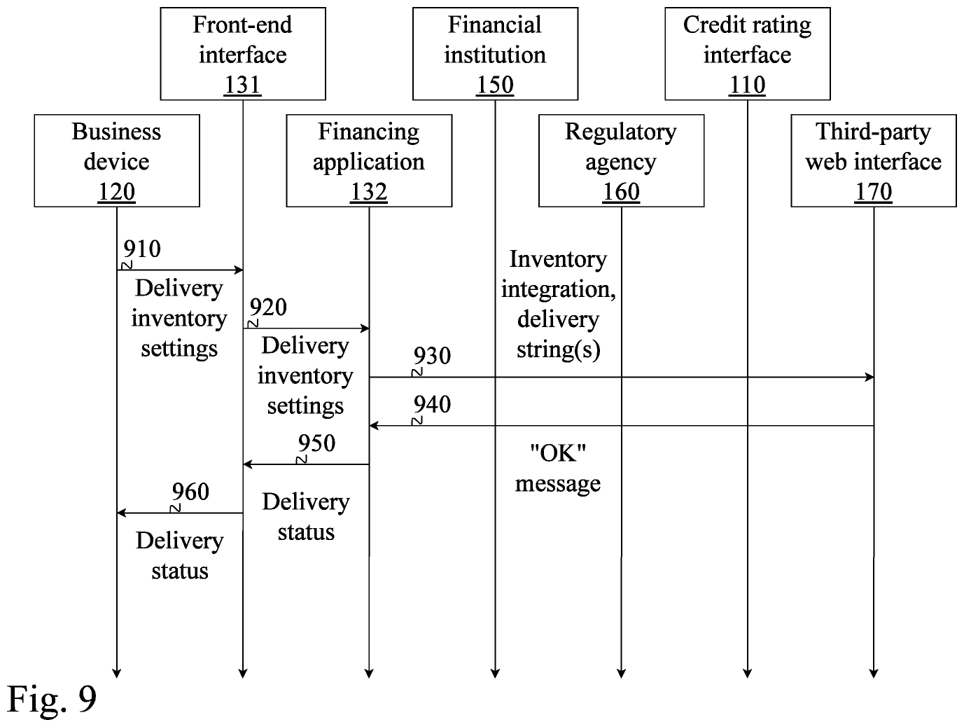

FIG. 9 is a message flow diagram illustrating the system being used to order wares (i.e. supplies for a restaurant), optimize the timing from the perspective of inventory numbers and estimated delivery time, handle the money for such transactions as a business line of credit, and communicate with the third party to complete the order. A Credit rating interface 110 exists as a software interface accessible over a network by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computer or computers, or a business-side mobile device or devices, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer refers to a laptop or desktop, or similar computing device that is not normally considered a “mobile device” as a tablet or phone is, but which also may communicate over a network and operate complex software such as web browsers and applications. A server exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore may be a database such as a SQL or NOSQL database, it may be a connection to cloud storage on another service such as one with WINDOWS AZURE™ or other cloud service providers, or may be another implementation of a datastore that may be used for server storage. The server, business-side devices 120, credit rating interface 110, and other services or interfaces, communicate with some combination of each other or other services and devices over a network, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls.

First a business device 120 communicates with a front-end interface 131 to allow users to specify delivery and inventory settings 910, which are sent to the back-end logic of the financial application 920. Delivery and inventory settings include integration or interfacing with any inventory management software, delivery or supplier software or website for ordering and communicating with the supplier, or manually entering inventory information if necessary 930. Such an attempt at interfacing or integration may be different for different services, and may comprise one of or some combination of, communicating over established API's for the third-party services, accessing special or sequestered databases for the third-party services to find relevant data to act on regarding the customer, a specialized socket connection with software to receive and send automated messages to the financial application, or merely sending automated emails to service providers and parsing their responses (which may also be automated) in an effort to at least partially integrate with them. Success or failure is sent back to the financing application 940, in one of many ways similar to the integration or interface with third party services, at which point the status of delivery and inventory integration is forwarded to the front-end interface 950 to be viewed by the business device when desired 960 on the graphical user interface.

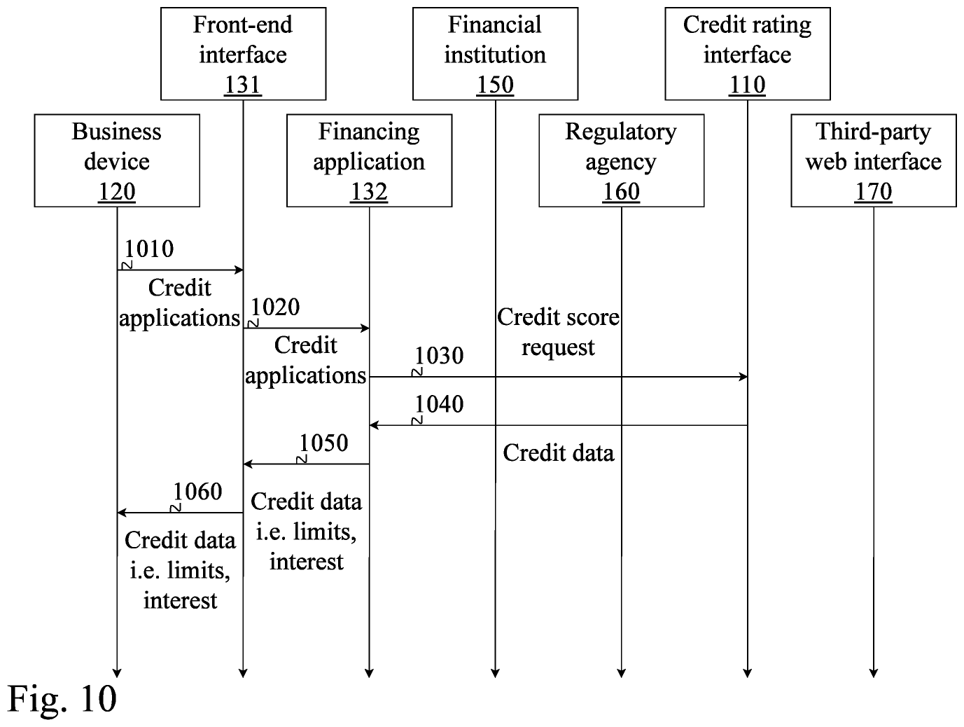

FIG. 10 is a message flow diagram illustrating a financial application evaluating credit worthiness of businesses and employees, and issuing and utilizing credit cards based on evaluations of individuals and businesses. A Credit rating interface 110 exists as a software interface accessible over a network by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computer or computers, or a business-side mobile device or devices, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer refers to a laptop or desktop, or similar computing device that is not normally considered a “mobile device” as a tablet or phone is, but which also may communicate over a network and operate complex software such as web browsers and applications. A server exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore may be a database such as a SQL or NOSQL database, it may be a connection to cloud storage on another service such as one with WINDOWS AZURE™ or other cloud service providers, or may be another implementation of a datastore that may be used for server storage. The server, business-side devices 120, credit rating interface 110, and other services or interfaces, communicate with some combination of each other or other services and devices over a network, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls.

First a business device 120 communicates with a front-end interface 131 to allow users to apply for credit lines or credit cards 1010, the requests being sent to the back-end logic of the financial application 1020. A credit score request is made, ideally automatically but potentially also manually by staff operating the financial application on the back-end or in a customer service role, with known credit reporting agencies such as EQ,UIFAX™ or others 1030. Insofar as automated attempts are made, such attempts at interfacing or integration for different services may comprise one of or some combination of, communicating over established API's for the third-party services, accessing special or sequestered databases for the third-party services to find relevant data to act on regarding the customer, a specialized socket connection with software to receive and send automated messages to the financial application, or merely sending automated emails to service providers and parsing their responses (which may also be automated) in an effort to at least partially integrate with them. When a credit request is properly made to the credit reporting or credit monitoring agency, a response may then be received 1040 either by email, socket communications, phone call, paper mail, or some other method, and used as part of or as the whole determination for credit lending to the business, which is then used to update the business account in the financial application that applied for credit. The update to the account information is visible to the business account administrators and includes important details about the application, whether it was approved, denied, the terms of the credit, credit limits, and so forth 1050, 1060.

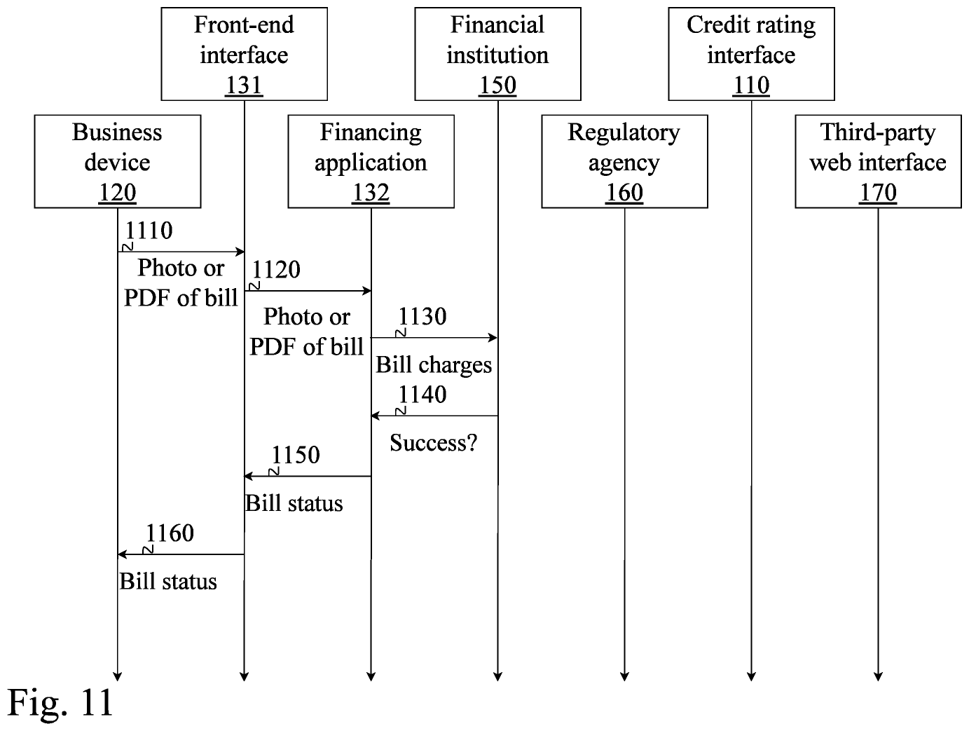

FIG. 11 is a message flow diagram illustrating a financial application tracking corporate expenses, scheduling payments for bills and other regular payments through the application as a creditor, and using Optical Character Recognition (“OCR”) to scan photographs of bills or invoices. A Credit rating interface 110 exists as a software interface accessible over a network by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computer or computers, or a business-side mobile device or devices, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer refers to a laptop or desktop, or similar computing device that is not normally considered a “mobile device” as a tablet or phone is, but which also may communicate over a network and operate complex software such as web browsers and applications. A server exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore may be a database such as a SQL or NOSQL database, it may be a connection to cloud storage on another service such as one with WINDOWS AZURE™ or other cloud service providers, or may be another implementation of a datastore that may be used for server storage. The server, business-side devices 120, credit rating interface 110, and other services or interfaces, communicate with some combination of each other or other services and devices over a network, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls.

A device with a connected camera, such as a web-camera connected to a computing device, a smartphone with a camera, or a tablet with a camera, may take a picture of a bill or invoice, or the bill or invoice may be scanned with an office scanner of some variety, before the scanned or photographed bill or invoice is sent to the application via the front-end interface 1110 over the internet. Included with the bill scan or photo, must be consent from at least one account or person on an account to split the invoice or bill between them, if that is what they desire, but if the purpose of scanning or photographing the bill is not to split it between multiple accounts, it does not require such consent from multiple persons. The data is handed to the backend logic of the application 1120, which then may make the appropriate charges to the consenting parties in the bill if applicable 1130 to the financial institution or institutions that are specified in the application settings, with a success or failure message returned 1140 from the institution, as is common in the art to receive at least a failure message when communications between two services or devices malfunction or are rejected for some reason. The purpose for scanning bills in this manner may be to split them between parties, or prepare them for payment plans supported by the financial application, or merely to have photographic evidence stored in the application of the invoice or bill, for recordkeeping purposes. The status of the bill, if paid or a payment plan is specified, is then returned to the front-end interface 1150 to display to the account administrators 1160.

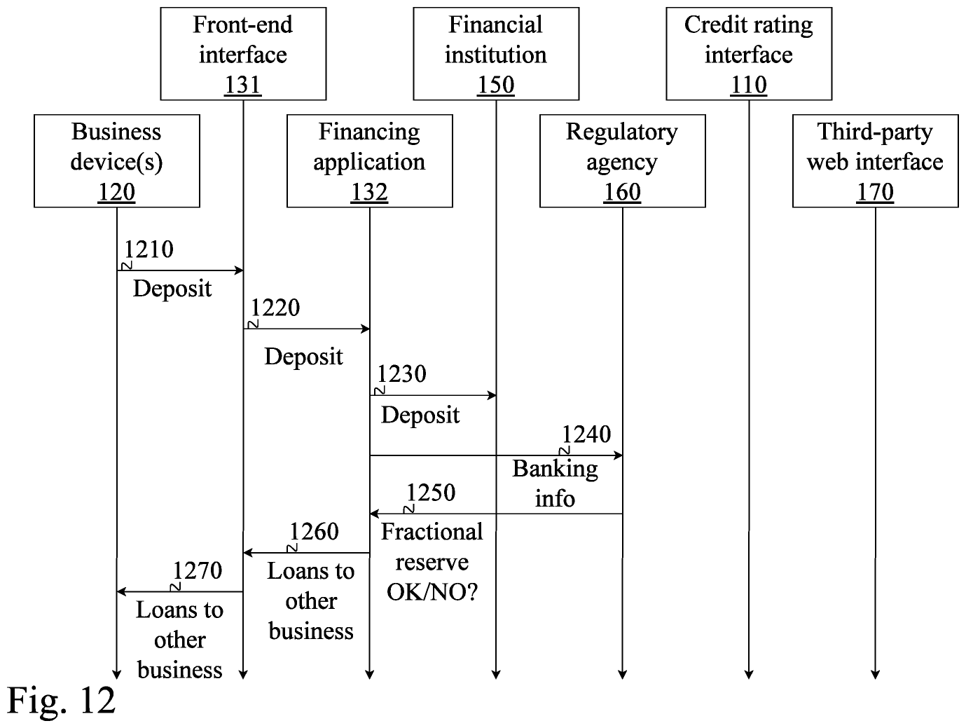

FIG. 12 is a message flow diagram of a financial application and accompanying system being used similarly to a fractional reserve banking system, where a business deposits funds, and a portion of the deposited money is used to fund other customers' credit. A Credit rating interface 110 exists as a software interface accessible over a network by other software systems, such as through an API, or some other common method of network interfacing between software systems, wherein the credit rating interface 110 is specifically an interface for communicating with and getting information from a credit rating agency or similar organization for credit rating and reporting purposes. In other words, a message can be sent to this interface, such as with an API call at a specific address and a verified token with the interface to identify the requestor, to request a credit score for a given Social Security Number (SSN), and the response may for instance be the credit score, or a failure message indicating why the message was rejected. There exist, as well, at least one but possibly a plurality of business-side devices 120 including a computer or computers, or a business-side mobile device or devices, where “business-side” in this context refers to a business that seeks to use the instant invention as a customer or client, the invention being designed to offer services to businesses. A mobile device in this or other contexts may refer to a mobile phone such as an IPHONE™ or ANDROID™ phone, a tablet, a personal digital assistant or PDA, a hybrid between a tablet and either a phone or laptop, or other mobile devices that may become common in the future for computing and networking purposes. A computer refers to a laptop or desktop, or similar computing device that is not normally considered a “mobile device” as a tablet or phone is, but which also may communicate over a network and operate complex software such as web browsers and applications. A server exists as well, a server being a computing device or a collection of computing devices which serve resources over a network (such as, but not limited to, websites and HTML pages over the Internet when you visit their address), and possesses a front-end web interface 131 which allows for a graphical user interface (“GUI”) and communications with external web services, a financing application 132 which represents the back-end logic of the server's main application and which comprises many software engines and components to offer specific operations and functionality to users, and a datastore to store data long-term. A financing application 132 may be comprised of code from one or multiple programming languages and paradigms, and may be one actively running application or several working in tandem, with the phrase “financing application” being an abstraction of the overall function of the business logic of the set of software programs that are running. A datastore may be a database such as a SQL or NOSQL database, it may be a connection to cloud storage on another service such as one with WINDOWS AZURE™ or other cloud service providers, or may be another implementation of a datastore that may be used for server storage. The server, business-side devices 120, credit rating interface 110, and other services or interfaces, communicate with some combination of each other or other services and devices over a network, which may be the Internet or a local or wide area network (LAN or WAN). Other services or institutions that a financial application 132 may communicate with include at least one financial institution 150 such as a bank, credit union, or payment system such as PAYPAL™, a regulatory agency 160 such as state or federal banking regulators, as may be required for certain practices, and a plurality of third-party web interface 170 which may include a variety of services such as delivery services, ware suppliers for inventory replenishment, third party bill splitting services or invoice services, and others. Such connections with services and institutions may be done with a combination of manual or automated communications, such as with email, socket communications, API calls and responses between the services, or phone calls. Data from a business device may be sent via the front end GUI, in the form of information and authorization for a financial deposit 1210, which is then passed to the backend logic of the application 1220. The deposition of funds is then relayed in an appropriate format to the requisite financial institutions, for instance perhaps the business has set up a PAYPAL™ account to send funds in this way to the operators of the financial application, in which case the PAYPAL™ account is polled for the funds and given the authorization as necessary, which is then deposited into the financial application's financial institution 1230. A regulatory agency 160 may be informed of the deposit however, as far as banking and crediting efforts are regulated according to local laws, for the reason that the funds are intended to be used for fractional reserve banking 1240, which the regulatory agency may deny or approve based on local laws 1250. Such communications with a regulatory agency may be done manually or automatically, wherein such an attempt at interfacing or integration may be different for different services, and may comprise one of or some combination of, communicating over established API's for the third-party services, accessing special or sequestered databases for the third-party services to find relevant data to act on regarding the customer, a specialized socket connection with software to receive and send automated messages to the financial application, or merely sending automated emails to service providers and parsing their responses (which may also be automated) in an effort to at least partially integrate with them. If the laws and regulatory agency allow for the financial application operators to operate fractional reserve banking practices, then according to the practice, loans that are made available to other businesses 1260, 1270 as normal, are funded at least partially with the funds deposited from the first business. In other words, business A may deposit funds equal to $6,500, with the financial application, to maintain a positive cash balance. Business B requests and is approved for a loan of $5,000. The financial application loans part of the $6,500 from business A to business B, covering the other part of the loan with funds available and owned by the operators of the financial application, making sure to hold enough funds so that any reasonable (which may change according to local laws) or expected withdrawals from accounts that may occur can still be covered with on-hand funds.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

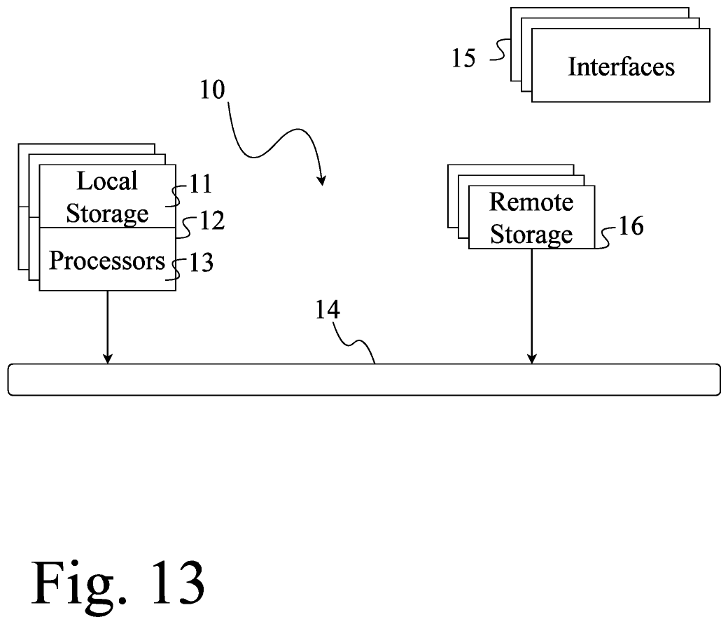

Referring now to FIG. 13, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 13 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

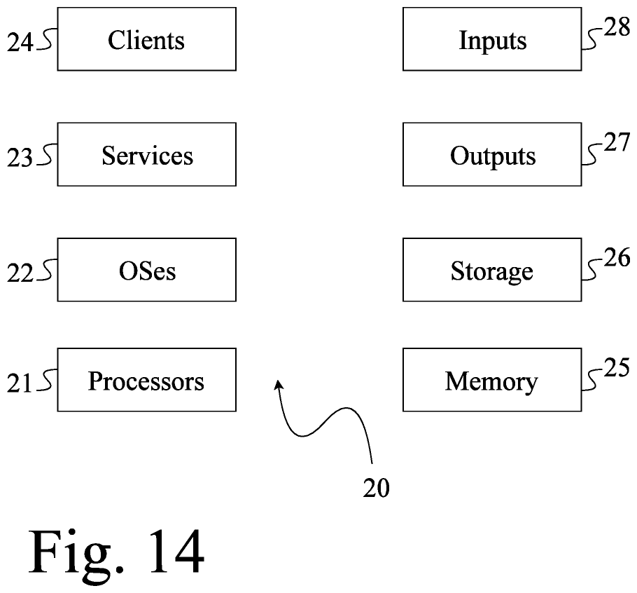

In some embodiments, systems according to the present invention may be implemented on a standalone computing system. Referring now to FIG. 14, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 13). Examples of storage devices 26 include flash memory, magnetic hard drive, CD-ROM, and/or the like.

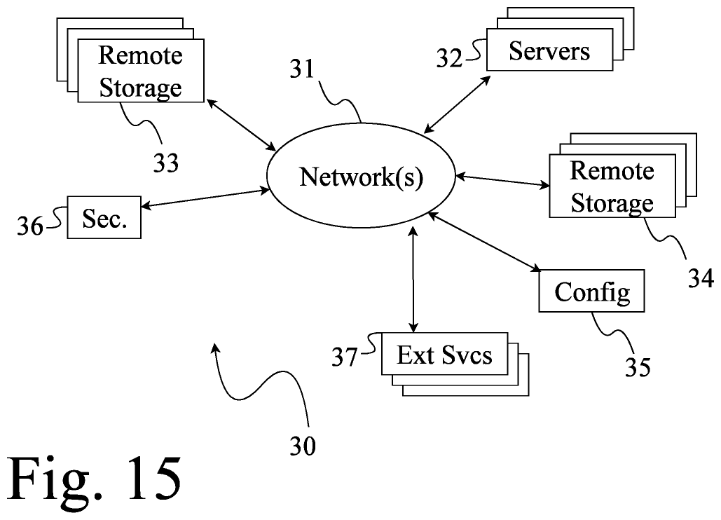

In some embodiments, systems of the present invention may be implemented on a distributed computing network, such as one having any number of clients and/or servers. Referring now to FIG. 15, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 14. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

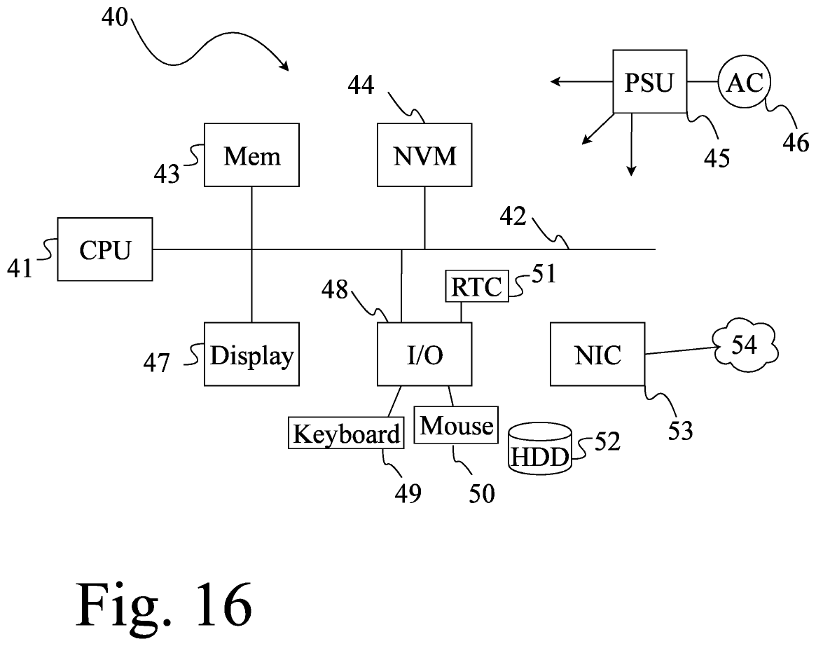

FIG. 16 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for financial services for abstraction of economies of scale for small businesses, comprising:
a financing server comprising a plurality of programming instructions stored in a memory of, and operating on a processor of, a computing device, wherein the programming instructions, when operating on the processor, cause the processor to:
receive input via a user interface;
register a business account for a business entity, the business account comprising a plurality of personnel accounts associated with the business entity, the business account and personnel accounts being provided via input from the user interface;
associate account settings with the business account, the account settings being received via input from the user interface and comprising at least financial information for at least one of the personnel accounts;
associate a plurality of third-party services with the business account, the third-party services being received via input from the user interface;
collect personnel information from input via the user interface and from the associated third-party services;
determine creditworthiness of the business and any associated personnel, the determination being based on analysis of all available information associated with the business account and any associated personnel accounts;
provide a plurality of financial services to the registered business account and at least a portion of the plurality of personnel accounts associated with the business entity, the plurality of financial services comprising at least one of:
delivering loan agreements and associated funds for specified uses to the business account, wherein the loan funds may be utilized for business costs including delivery and shipment of goods, payroll, corporate expenses, and utility bills associated with the business account;
receiving a funds deposit to the business account either manually via input from the user interface or automatically according to scheduling information associated with the business account;
utilizing fractional reserve banking techniques to use deposited funds to finance other business accounts registered with the financing server, wherein the fractional reserve banking techniques are optimized based on the business entity's expected and historical costs and timing of withdrawals and payments;
developing an individual credit worthiness rating for each business account and personnel account associated with the business account, wherein the individual credit worthiness rating is used to allow for credit to be issued to each business account and personnel account with rates and maximums individual to the business account and personnel account in question;
utilizing an optical character recognition engine to detect and recognize characters in a scanned bill for the purpose of digital financing of bills;
interfacing with third party entities including at least third party delivery companies on behalf of the registered business account and facilitating payment for services including to third party entities on behalf of the registered business account; and
detecting fraudulent bill recognition attempts and fraudulent transactions on the part of either or both of a business account or a plurality of personnel accounts.

2. A method for financial services for abstraction of economies of scale for small businesses, comprising the steps of:
receiving, at a financing server, input via a user interface;
registering a business account for a business entity, the business account comprising a plurality of personnel accounts associated with the business entity, the business account and personnel accounts being provided via input from the user interface;
associating account settings with the business account, the account settings being received via input from the user interface and comprising at least financial information for at least one of the personnel accounts;
associating a plurality of third-party services with the business account, the third-party services being received via input from the user interface;
collecting personnel information from input via the user interface and from the associated third-party services;
determining creditworthiness of the business and any associated personnel, the determination being based on analysis of all available information associated with the business account and any associated personnel accounts;
providing a plurality of financial services to the registered business account and at least a portion of the plurality of personnel accounts associated with the business entity, the plurality of financial services comprising at least one of:
delivering loan agreements and associated funds for specified uses to the business account, wherein the loan funds may be utilized for business costs including delivery and shipment of goods, payroll, corporate expenses, and utility bills associated with the business account;
receiving a funds deposit to the business account either manually via input from the user interface or automatically according to scheduling information associated with the business account;
utilizing fractional reserve banking techniques to use deposited funds to finance other business accounts registered with the financing server, wherein the fractional reserve banking techniques are optimized based on the business entity's expected and historical costs and timing of withdrawals and payments;
developing an individual credit worthiness rating for each business account and personnel account associated with the business account, wherein the individual credit worthiness rating is used to allow for credit to be issued to each business account and personnel account with rates and maximums individual to the business account and personnel account in question;
utilizing an optical character recognition engine to detect and recognize characters in a scanned bill for the purpose of digital financing of bills;
interfacing with third party entities including at least third party delivery companies on behalf of the registered business account and facilitating payment for services including to third party entities on behalf of the registered business account; and
detecting fraudulent bill recognition attempts and fraudulent transactions on the part of either or both of a business account or a plurality of personnel accounts.
